(19) United States
(12) Patent Application Publication
(10) Pub. No.: US 2012/0143866 A1
(43) Pub. Date: Jun. 7, 2012

(54) Client Performance Optimization by Delay-Loading Application Files with Cache

(75) Inventors: Frederico Mameri, Seattle, WA (US); Sterling Crockett, Bothell, WA (US); Timothy McConnell, Kirkland, WA (US); Zachary Nation, Seattle, WA (US)

(73) Assignee: MICROSOFT CORPORATION, Redmond, WA (US)

(21) Appl. No.: 12/958,603

(22) Filed: Dec. 2, 2010

(51) Int. Cl. G06F 17/30

(52) U.S. Cl. 707/737; 707/E17.089

(57) ABSTRACT

Systems and methods for minimizing start-up and implementation latency of a web application hosted in a computing system environment. Latency mitigation is accomplished via a programmatic approach to reduce the number of files or script needed for an initial boot of the web application. Remaining files are loaded either as needed or in a background process.

### BACKGROUND

Web application complexity is generally proportional to an amount of script that is needed to be downloaded and executed in a client application for a particular web page. This can introduce performance issues, as script files typically need to be downloaded and fully parsed at application boot time. Such undesired latency can affect user quality of experience manifested by a decrease in perceived performance of the web application.

### SUMMARY

In one aspect, a method for partitioning files of a web application is disclosed. The method includes receiving a plurality of files associated with the web application at a computing device, wherein each of the plurality of files include a plurality of constituent content; parsing each of the plurality of files into respective constituent content at the computing device; implementing an analysis of one or more relationships between the parsed constituent content at the computing device; organizing the parsed constituent content into a plurality of partitions based on the analysis of the one or more relationships; and generating a plurality of output files each corresponding to one of the plurality of partitions.

In another aspect, a computing device is disclosed including a processing unit and a system memory connected to the processing unit, the system memory including instructions that, when executed by the processing unit, cause the processing unit to implement a partitioning module configured for partitioning files of a web application. The partitioning module includes an input module configured to receive a plurality of input files. Each of the plurality of input files is associated with the web application and includes at least one logical unit of executable instructions. The partitioning module also includes a parse module configured to parse each of the plurality of input files into a plurality of nodes each corresponding to a respective logical unit of executable instructions and an analysis module configured to perform an analysis of relationships between the plurality of nodes and assign a weight to each of the plurality of nodes based on the relationships. The relationships comprise an inbound call frequency and an inbound call dependency. The partitioning module also includes a partition module configured to cluster the plurality of nodes into a plurality of partitions based on weight assigned to each of the plurality of nodes, content of the plurality of partitions including respective logical unit of executable instructions associated with corresponding nodes and an output module configured to generate an output file corresponding to each of the plurality of partitions.

In yet another aspect, a computer readable storage medium having computer-executable instructions is disclosed. The computer-executable instructions, when executed by a computing device, cause the computing device to perform steps including receiving a plurality of files associated with the web application. Each of the plurality of files include a plurality of constituent content, and one or more of the plurality of files comprise a source language different from other files of the plurality of files. The steps also include parsing each of the plurality of files into respective constituent content and associating an instance of parsed constituent content with a node of a dependency graph. Each node of the dependency graph represents a set of logical instructions of parsed constituent content selected from a function and a method. The steps also include implementing an analysis of a plurality of relationships between the parsed constituent content. The plurality of relationships include a call dependency including a number of nodes of the dependency graph including a reference to each respective node of the plurality of nodes, and a call frequency including a number of incoming references to a node of the dependency graph from other nodes of the dependency graph. The steps also include organizing the parsed constituent content into a plurality of partitions based on the analysis of the plurality of relationships. The plurality of partitions are selectively organized to include constituent content most related to other constituent content and to minimize a number of references from constituent content of one of the plurality of partitions to another of the plurality of partitions; generating a plurality of output files each corresponding to one of the plurality of partitions. The steps also include transferring the plurality of output files to at least one other computing device configured to host the web application.

This Summary is provided to introduce a selection of concepts, in a simplified form, that are further described below in the Detailed Description. This Summary is not intended to identify key or essential features of the claimed subject matter, nor is it intended to be used in any way to limit the scope of the claimed subject matter.

### DESCRIPTION OF THE DRAWINGS

Aspects of the present disclosure may be more completely understood in consideration of the following detailed description of various embodiments in connection with the accompanying drawings.

FIG. 1 shows a flowchart for an example method for partitioning files of a web application.

FIG. 2 shows an example networked computing environment.

FIG. 3 shows an example computing device of the environment of FIG. 2.

FIG. 4 shows example communications between an example client device and an example server device.

FIG. 5 shows an example partitioning module.

FIG. 6 shows an example parsed file.

FIG. 7 shows an example partition file.

FIG. 8 shows a flowchart for an example method for executing a web application in a browser.

### DETAILED DESCRIPTION

The present disclosure is directed to systems and methods for minimizing start-up and implementation latency of a web application hosted in a computing system environment. In general, latency mitigation is accomplished via a programmatic approach to reduce the number of files or script needed for an initial boot of the web application. Remaining files are loaded either as needed or in a background process. Although not so limited, an appreciation of the various aspects of the present disclosure will be gained through a discussion of the examples provided below.

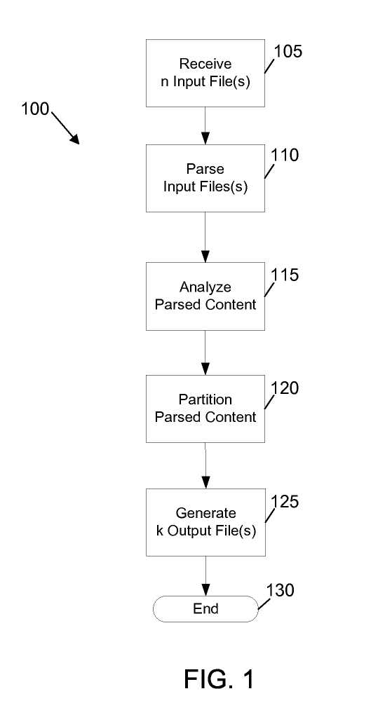

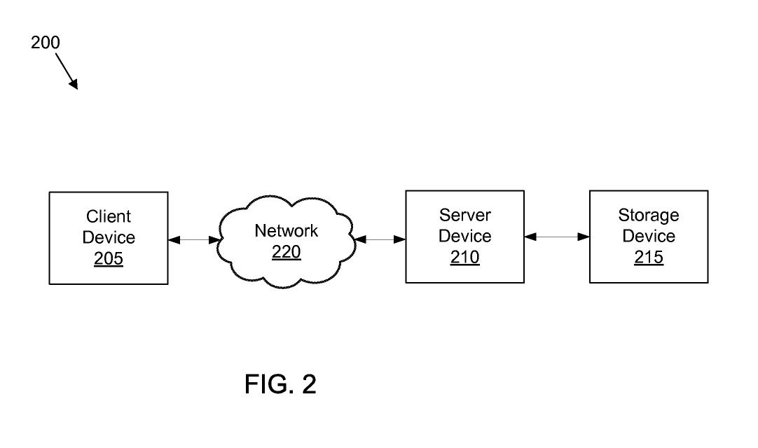

Referring now to FIG. 1, an example method 100 for partitioning files of a web application is shown. In some embodiments, the method 100 is implemented on a client computing device such as described below in connection with FIGS. 2-8. Other embodiments are possible.

The method 100 begins at an input operation 105. The example input operation 105 is configured to receive an integer number N input files. Each of the respective N input files can correspond to a script file. In example embodiments, a script file is a client-side program that may accompany an HTML document or be embedded directly therein. An example script file includes a JavaScript script file. Others types of script files are possible.

The N input files may generally be similar or dissimilar, being generated by different tools and/or written in different source languages. The example method 100 is therefore generally applicable to any code or software such as code being hand-written, pre-processed, generated by compilers (e.g., Script#), tool generated (e.g., Visual Studio), and others. Additionally, the example input operation 105 is configured to handle and receive libraries (e.g., JQuery). This also provides validation across all project files.

Operational flow proceeds to a parse operation 110. The example parse operation 110 is configured to logically parse each of the respective N input files into constituent content. Example constituent content includes individual functions, methods, or any other logical unit of code or instructions. In one embodiment, the N input files are parsed into an integer number M nodes, in which each of the respective M nodes is associated with a block of code or instructions. Other embodiments are possible.

Operational flow then proceeds to an analysis operation 115. The example analysis operation 115 is configured to perform a static analysis of one or more relationships between the parsed constituent content as generated by the parse operation 110. Example relationships include call dependency, call frequency, and others. In example embodiments, call dependency includes a count of how many of the M nodes reference a given node within the M nodes.

Call frequency includes a count of how many times a given node of the M nodes is referenced by other nodes of the M nodes. Examples of a reference include a function call, a method call, and others. Such relationships can be represented by a directed graph, such as a dependency graph. In the example embodiment, an inbound edge to a given node of the M nodes, as embodied in a dependency graph, represents a single reference made to the given node by another node of the M nodes. Other embodiments are possible.

Operational flow proceeds to a partition operation 120. The example partition operation 120 is configured to logically cluster and organize the M nodes into a configurable integer number K partitions, based on the one or more relationships as evaluated by the analysis operation 115. In general, nodes of the M nodes that call or refer to each most frequently are grouped together in a respective partition. The resulting K partitions therefore group those nodes of the M nodes that are most related. In example embodiments, the partition operation 120 optimally generates the K partitions to minimize number of dependency graph edges that traverse a respective partition. Other embodiments are possible.

Operational flow then proceeds to an output operation 125. The example output operation 125 is configured to receive the K partitions and generate a corresponding integer number K output files. Each of the K output files contain respective constituent content represented by those nodes M that are contained within a given corresponding partition K.

In example embodiments, each of the respective K output files can correspond to a JavaScript script file. In this manner, the example method 100 is configured as a JavaScript-to-JavaScript compiler. However, as described in more detail below, the example method 100 can be extended to any technology involving a client downloading and executing files from a server.

Following generation of the K output files by the output operation 125, process flow proceeds to an end module 130 which corresponds to termination of the example method 100. In some embodiments, the end module 130 further corresponds to transferring the K output files to a server computing device that hosts a web application, such as described below in connection with FIGS. 2-8.

Referring now to FIG. 2, an example networked computing environment 200 is shown in which aspects of the present disclosure may be implemented. The example networked computing environment 200 includes a client device 205, a server device 210, a storage device 215, and a network 220. However, other embodiments of the example networked computing environment 200 are possible as well. For example, the networked computing environment 200 may generally include more or fewer devices, networks, and other components as desired.

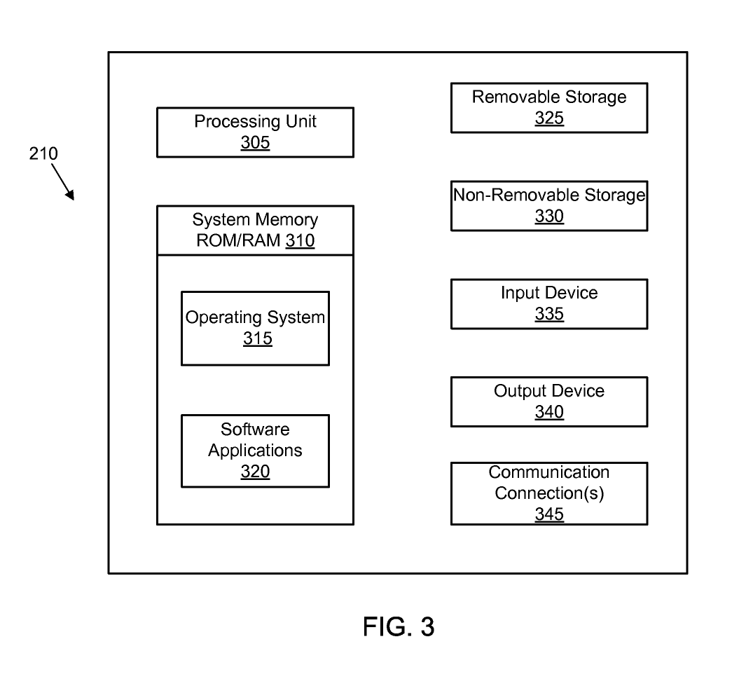

The client device 205 and the server device 210 are general purpose computing devices, such as described below in connection with FIG. 3. In example embodiments, the server device 210 is a business server that implements business processes. Example business processes include messaging processes, collaboration processes, data management processes, and others. SHAREPOINT® collaboration server from Microsoft Corporation is an example of a business server that implements business processes in support of collaboration, file sharing and web publishing.

In some embodiments, the server device 210 includes a plurality of interconnected server devices operating together in a “Farm” configuration to implement business processes Still other embodiments are possible.

The storage device 215 is a data storage device such as a relational database or any other type of persistent data storage device. The storage device 215 stores data in a predefined format such that the server device 210 can query, modify, and manage data stored thereon. Examples of such a data storage device include mailbox stores and address services such as ACTIVE DIRECTORY® directory service from Microsoft Corporation. Other embodiments of the storage device 215 are possible.

The network 220 is a bi-directional data communication path for data transfer between one or more devices. In the example shown, the network 220 establishes a communication path for data transfer between the client device 205 and the server device 210. In general, the network 220 can be of any of a number of wireless or hardwired WAN, LAN, Internet, or other packet-based communication networks such that data can be transferred among the elements of the example networked computing environment 200. Other embodiments of the network 220 are possible as well.

Referring now to FIG. 3, the server device 210 of FIG. 2 is shown in further detail. As mentioned above, the server device 210 is a general purpose computing device. Example general purpose computing devices include a desktop computer, laptop computer, personal data assistant, smartphone, and others.

The server device 210 includes at least one processing unit 305 and a system memory 310. The system memory 310 can store an operating system 315 for controlling the operation of the server device 210 or another computing device. One example operating system 315 is the WINDOWS® operating system from Microsoft Corporation.

The system memory 310 may also include one or more software applications 320 and may include program data. Software applications 320 may include many different types of single and multiple-functionality programs, such as a server program, an electronic mail program, a calendaring program, an Internet browsing program, a spreadsheet program, a program to track and report information, a word processing program, and many others. One example multi-functionality program is the Office suite of business applications from Microsoft Corporation.

The system memory 310 can include physical computer readable storage media such as, for example, magnetic disks, optical disks, or tape. Such additional storage is illustrated in FIG. 3 by removable storage 325 and non-removable storage 330. Computer readable storage media can include physical volatile and nonvolatile, removable and non-removable media implemented in any method or technology for storage of information, such as computer readable instructions, data structures, program modules, or other data. Computer readable storage media can also include, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by server device 210. Any such computer storage media may be part of or external to the server device 210.

Communication media is distinguished from computer readable storage media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, communication media includes wired media such as a wired network or direct-wired connection, and wireless media such as acoustic, RF, infrared and other wireless media.

The server device 210 can also have any number and type of an input device 335 and output device 340. An example input device 335 includes a keyboard, mouse, pen, voice input device, touch input device, and others. An example output device 340 includes a display, speakers, printer, and others. The server device 210 can also contain a communication connection 345 configured to enable communications with other computing devices over a network (e.g., network 220 of FIG. 2) in a distributed computing system environment.

In example embodiments, the client device 205 of FIG. 2 is configured similar to the server device 210 described above.

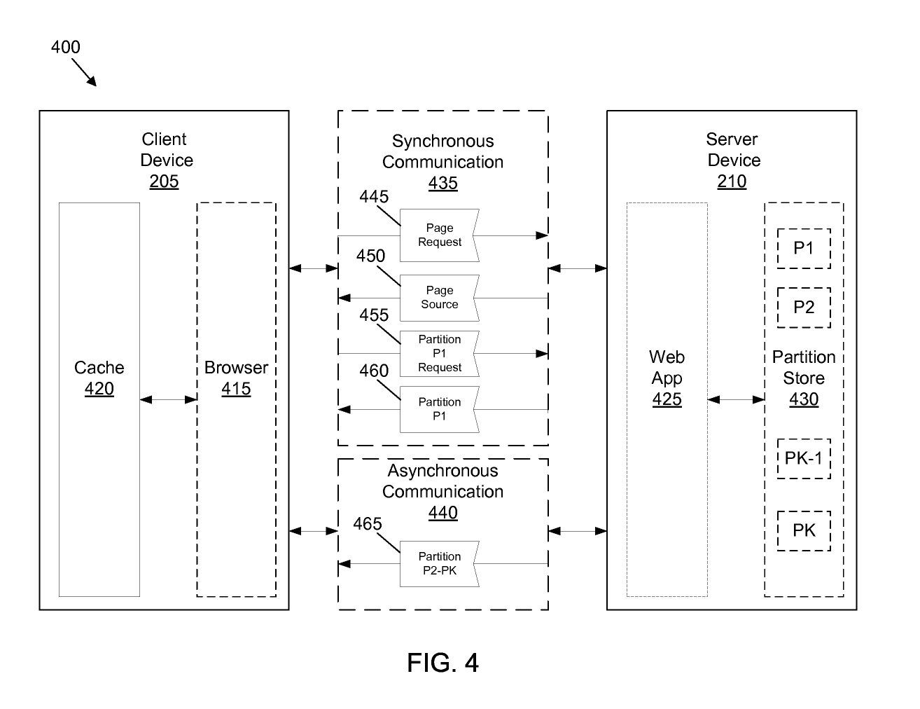

Referring now to FIG. 4, an example schematic block diagram 400 illustrates example communications between the client device 205 and the server device 210 in accordance with the present disclosure. Other embodiments of the diagram 400 are possible. For example, the diagram 400 may generally include more or fewer devices, and other components as desired.

The client device 205 includes a browser 415 and a local cache 420. The browser 415 includes logical modules of software of a client application executing on the client device 205 and configured for retrieving, presenting, and traversing information resources over a network (e.g., network 220). The local cache 420 includes physical computer readable storage media that stores data so that future requests for that data can quickly and efficiently be served to the browser 415.

The server device 210 includes a web application 425 and a partition store 430. The web application 425 includes logical modules of software of a server application executing on the server device 210, functionality of the web application being accessed over a network (e.g., network 220). The partition store 430 includes logical modules of software stored on the server device 210 that implements various functionality of the web application 425, as described in further detail below.

Communications within the example diagram 400 generally include a synchronous communication channel 435 and an asynchronous communication channel 440.

In example embodiments, a page request message 445 corresponding to a user interacting with the browser 415 to access a web page (e.g., http://www.microsoft.com) for a first time is transferred from the client device 205 to the server device 210 via the synchronous communication channel 435. The web application 425 is configured to receive and interpret the page request message 445 and return a page source message 450 that includes instructions for rendering the requested web page.

In example embodiments, the page source message 450 includes a reference to a partition P₁ that the browser 415 is attempting to load and execute such that the user can fully experience the requested web page. Partitions P₁-P_{K}, where K>1, are contained within the partition store 430 on the server device 210. In general, the partitions P₁-P_{K} are formed in a manner similar to that described above in connection with FIG. 1.

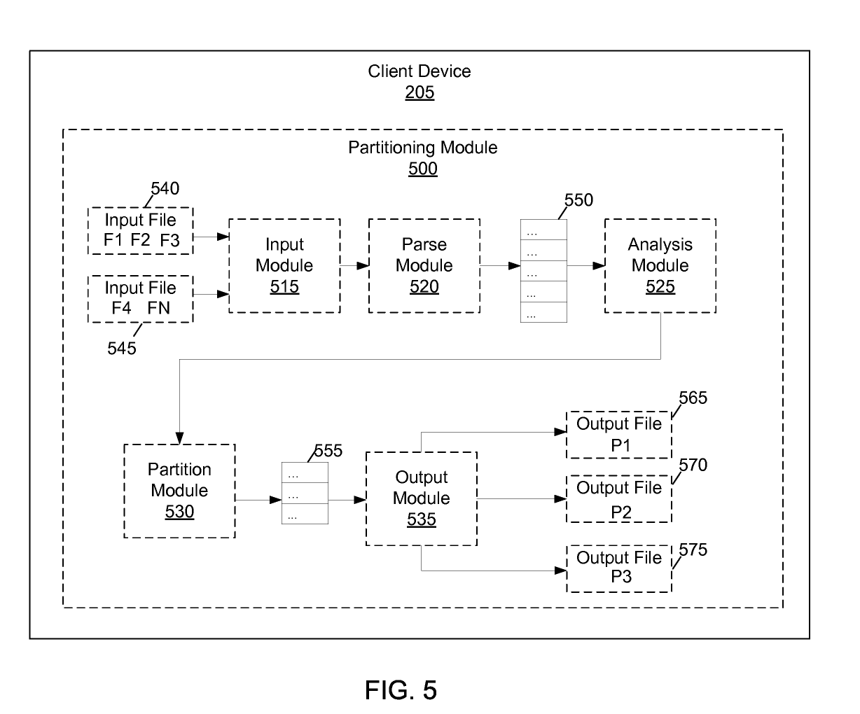

The browser 415 is configured to receive and interpret the page source message 450, and send a partition request message 455 to the web application 425 including a request to download the partition P₁. In general, the partition P₁ is a priority partition of the partitions P₁-P_{K} and includes a minimal amount of script and other data needed to render the requested web page within the browser 415, as described in further detail below in connection with FIG. 5-9.

The web application 425 is configured to receive and interpret the partition request message 455 and return a priority partition message 460 that includes the partition P₁. In some embodiments, the browser 415 is configured to store the partition P₁ in the local cache 420 and execute the partition P₁ from the local cache 420 as needed by browser 415. Other embodiments are possible.

As mentioned above, communications within the example diagram 400 additionally includes an asynchronous communication channel 440. In example embodiments, the browser 415 is additionally configured to receive and interpret a background partition message 465 to download and store the partitions P₂-P_{K} in the local cache 420.

In general, the download of the partitions P₂-P_{K} is a background process that can provide the browser 415 fast access to script and other information contained within the partitions P₂-P_{K} as the user navigates functionality and other web pages of the web application 425. Such an implementation is possible because the partitions P₁-P_{K} are static, as opposed to a per-page or per-request partition approach. In this manner, the local cache 420 may be taken advantage of to avoid unnecessary roundtrips to the server device 210, making execution of functionality of the web application 425 within the browser 415 faster and reducing the load on the server device 210.

Referring now to FIGS. 5-7, an example partitioning module 500 is shown. The partitioning module 500 includes logical modules of software executing on the client device 205 for partitioning files of a web application, similar to the example method 100 described above with respect to FIG. 1.

As depicted in FIG. 5, the partitioning module 500 includes an input module 515, a parse module 520, an analysis module 525, a partition module 530, and an output module 535.

In general, the example input module 515 is configured to receive an integer number N input files. In the example shown N=2, where the input module 515 receives a first input file 540 and a second input file 545. The first input file 540 is populated with a function F₁, a function F₂, and a function F₃. The second input file 545 is populated with a function F₄ and a function F_{N}. In one embodiment, the first input file 540 and second input file 545 correspond to a JavaScript script file. Other embodiments are possible.

The input module 515 is additionally configured to transfer the first input file 540 and the second input file 545 to the parse module 520. The parse module 520 is configured to logically parse the first input file 540 and the second input file 545, and transfer a parsed file 550 to the analysis module 525. Other embodiments are possible. For example, in some embodiments the parsed file 550 is directly retrieved from computer readable storage media.

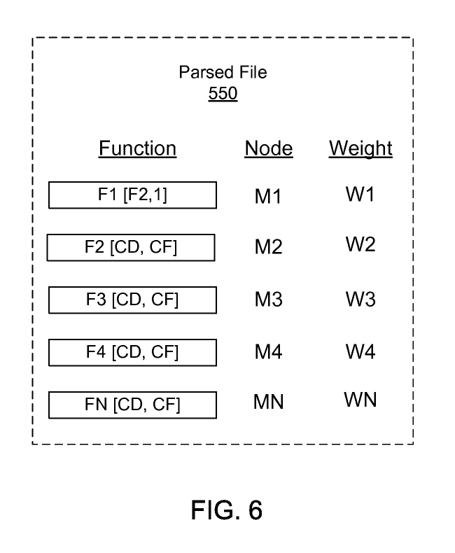

As depicted in FIG. 6, the parsed file 550 is a populated with individual entries corresponding to functions F_{1-N} of the first input file 540 and the second input file 545. In example embodiments, each of the respective functions of the first input file 540 and the second input file 545 are associated with corresponding nodes M₁-M_{N}. For example, function F₁ is associated with a node M₁, function F₂ is associated with a node M₂, etc.

The analysis module 525 is configured to perform an analysis of relationships between the nodes M₁-M_{N} of the parsed file 550 to determine a corresponding call dependency CD and a call frequency CF, and transfer results of the analysis to the partition module 530. Call dependency CD evaluation includes determining which of the nodes M₁-M_{N} references another of the nodes M₁-M_{N}. For example, node M₁ corresponding to function F₁ includes a reference to node M₂ corresponding to function F₂ (e.g., F₁[F₂, 1]). Call frequency CF evaluation includes determining how many times a given node of the nodes M₁-M_{N} references another of the nodes M₁-M_{N}. Continuing with the above example, node M₁ is shown including a single reference to node M₂ (e.g., F₁[F₂, 1]). Other embodiments are possible. For example, any given node of the nodes M₁-M_{N} can reference one or more of the other nodes M₁-M_{N} and number of times.

Results of the analysis of the relationships between the nodes M₁-M_{N} corresponds to a weighting of the nodes M₁-M_{N}, represented by weights W₁-W_{N}. For example, as depicted in FIG. 6, node M₁ is associated with a weight W₁, node M₂ is associated with a weight W₂, etc.

Each of the weights W₁-W_{N} can be quantified by an algorithm. For example, in one embodiment, the weights W₁-W_{N} may be evaluated as a function of an inbound call dependency ICD and an inbound call frequency ICF. In the above example, in which the node M₁ includes a reference to node M₂, the weighting factor is assigned to the node M₂. In another embodiment, each of the respective weights W₁-W_{N} may be evaluated as a function of inbound call dependency ICD, inbound call frequency ICF, and an additional term corresponding to a manual weighting MW. In the example embodiment, the manual weighting MW is provided from a user such as a programmer or developer at application build-time. Still other embodiments are possible.

As mentioned above, the analysis module 525 is generally configured to transfer results of the analysis to the partition module 530. The partition module 530 is configured to logically organize and cluster the nodes M₁-M_{N} into an integer number K partitions based on the weights W₁-W_{N} as evaluated by the analysis module 525, generate a partition file 555 including the K partitions, and transfer the partition file 555 to the output module 535.

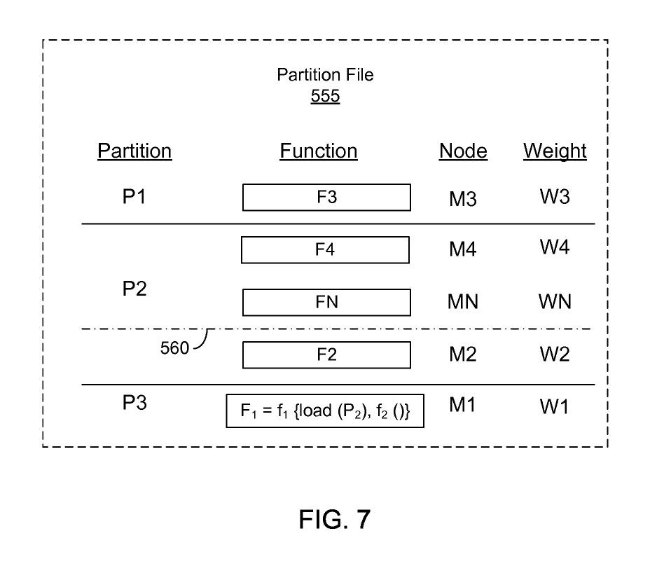

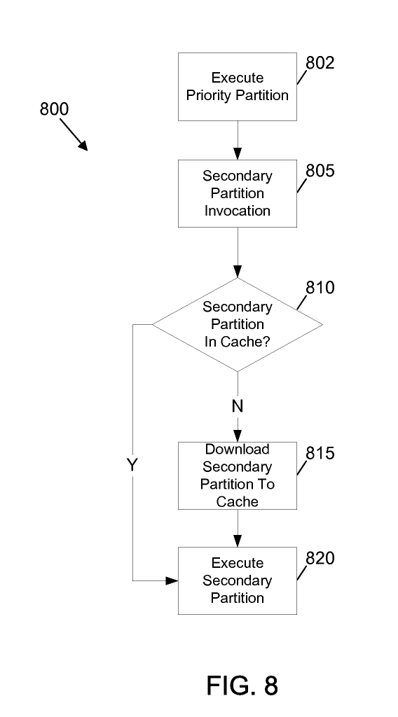

As depicted in FIG. 7, the partition file 555 includes the nodes M1-MN organized according to weight I which W₃>W₄>W_{N}>W₂>W₁, and clustered into a partition P₁ populated with node M₃, a partition P₂ populated with node M₄, M_{N}, and M₂, and a partition P₃ populated with node M₁. In the example embodiment, K=3. When forming the partitions P₁-P₃, the partition module 530 is additionally configured to modify each function call to a function contained in a different partition with a reference to the respective partition, as described further below in connection with FIG. 8. In the above example, in which the node M₁ includes a reference to node M₂, the reference to node M₂ (e.g., corresponding to function F₂) is programmatically modified with instruction or code referring to the partition P₂ that is configured to load partition P₂ prior to calling function F₂. For example, where F₁=f₁{f₂( )}, F₁ is modified to F₁=f₁ {load (P₂), f₂( )}. Still other embodiments are possible.

The partitions P₁-P₃ are generally formed in order of importance. In the example embodiment, the partition P₁ corresponds to a priority importance partition, partition P₂ corresponds to a secondary importance partition, and partition P₃ corresponds to a tertiary partition. In example embodiments, the partitions P₁-P₃ are formed programmatically. However, other embodiments are possible. For example, clustering of the nodes M₁-M_{N}, and therefore generation of the partitions P₁-P₃ may be manually adjusted. For example, the partition P₃ may be manually adjusted to include node M₂, shown in FIG. 7 as an intermittent line 560.

In general, the output module 535 is configured to receive the partition file 555 and generate a first output file 565, a second output file 570, and a third output file 575 corresponding to and containing the partitions P₁-P₃. Subsequently, the first output file 565, second output file 570, and third output file 575 may be transferred to a server computing device that hosts a web application, such as described above in connection with FIG. 4. In some embodiments, the first output file 565, second output file 570, and third output file 575 correspond to a JavaScript script file. However, other embodiments are possible.

Referring now to FIG. 8, an example method 800 for executing a web application in a browser is shown according to the principles of the present disclosure. In one embodiment, the example method 800 is implemented by a client computing device including a browser and local cache in communication with a server computing device including a web application and partition store similar to corresponding elements described above in connection with FIGS. 1-7.

The method 800 begins at an operation 802. At operation 802, a priority importance partition comprising script and other data necessary to render a requested web page within the browser is executing on the client computing device. Operational flow then proceeds to an operation 805. At operation 805, the browser encounters invocation of a secondary importance partition within the priority importance partition.

Operational flow then proceeds to an operation 810. At operation 810, the browser queries the local cache to determine whether the secondary importance partition is stored in the local cache.

When the browser determines that the secondary importance partition is stored in the local cache, operational flow proceeds to an operation 820 in which the secondary importance partition is loaded and executed in the browser application from the local cache.

When the browser determines that the secondary importance partition is not stored in the local cache, operational flow proceeds to an operation 815 in which the secondary importance partition is downloaded from the web application to the local cache, the secondary importance partition being retrieved from the partition store. Following download of the secondary importance partition, operational flow proceeds to the operation 820 in which the secondary importance partition is loaded and executed in the browser application from the local cache. Other embodiments are possible.

The example embodiments described herein can be implemented as logical operations in a computing device in a networked computing system environment. The logical operations can be implemented as: (i) a sequence of computer implemented instructions, steps, or program modules running on a computing device; and (ii) interconnected logic or hardware modules running within a computing device.

For example, the logical operations can be implemented as algorithms in software, firmware, analog/digital circuitry, and/or any combination thereof, without deviating from the scope of the present disclosure. The software, firmware, or similar sequence of computer instructions can be encoded and stored upon a computer readable storage medium and can also be encoded within a carrier-wave signal for transmission between computing devices.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for partitioning files of a web application, the method comprising:
receiving a plurality of files associated with the web application at a computing device, wherein each of the plurality of files include a plurality of constituent content;
parsing each of the plurality of files into respective constituent content at the computing device;
implementing an analysis of one or more relationships between the constituent content at the computing device;
organizing the constituent content into a plurality of partitions based on the analysis of the relationships; and
generating a plurality of output files each corresponding to one of the plurality of partitions.

2. The method of claim 1, further comprising receiving one or more other files at the computing device comprising a source language different from the plurality of files.

3. The method of claim 1, further comprising associating an instance of parsed constituent content with a node of a dependency graph.

4. The method of claim 3, wherein each node of the dependency graph represents a set of logical instructions of parsed constituent content selected from a group including: a function; and a method.

5. The method of claim 3, wherein the relationships comprise a call dependency and a call frequency.

6. The method of claim 5, wherein the call dependency includes a list of nodes of the dependency graph including a reference to each respective node of the list of nodes.

7. The method of claim 5, wherein the call frequency includes a number of incoming references to a node of the dependency graph from other nodes of the dependency graph.

8. The method of claim 1, further comprising selectively forming each of the plurality of partitions to include constituent content most related to other constituent content.

9. The method of claim 1, further comprising selectively forming each of the plurality of partitions to minimize a number of references from constituent content of one of the plurality of partitions to another of the plurality of partitions.

10. The method of claim 1, wherein each of the plurality of output files correspond to a JavaScript script file.

11. The method of claim 1, further comprising transferring the plurality of output files to at least one other computing device configured to host the web application.

12. A computing device, comprising:
a processing unit;
a system memory connected to the processing unit, the system memory including instructions that, when executed by the processing unit, cause the processing unit to implement a partitioning module configured for partitioning files of a web application, wherein the partitioning module comprises:
an input module configured to receive a plurality of input files, wherein each of the plurality of input files are associated with the web application and include at least one logical unit of executable instructions;
a parse module configured to parse each of the plurality of input files into a plurality of nodes each corresponding to a respective logical unit of executable instructions;
an analysis module configured to perform an analysis of relationships between the plurality of nodes and assign a weight to each of the plurality of nodes based on the relationships, wherein the relationships comprise an inbound call frequency and an inbound call dependency;
a partition module configured to cluster the plurality of nodes into a plurality of partitions based on weight assigned to each of the plurality of nodes, content of the plurality of partitions including respective logical unit of executable instructions associated with corresponding nodes; and
an output module configured to generate an output file corresponding to each of the plurality of partitions.

13. The computing device of claim 12, wherein the inbound call dependency includes a list of nodes including a reference to each respective node of the plurality of nodes.

14. The computing device of claim 12, wherein call frequency includes a number of incoming references to a node from other nodes of the plurality of nodes.

15. The computing device of claim 12, wherein weight assigned to each of the plurality of nodes is further based on a manual weighting factor.

16. The computing device of claim 12, wherein the partition module is further configured to selectively form each of the plurality of partitions to include nodes of the plurality of nodes that are most related.

17. The computing device of claim 12, wherein the partition module is further configured to modify a function call of a function to include a reference to a partition of the plurality of partitions.

18. The computing device of claim 12, wherein the partition module is further configured to receive manual adjustment of the plurality of partitions.

19. The computing device of claim 12, wherein the output module is further configured to transfer the output file corresponding to each of the plurality of partitions to at least one other computing device configured to host the web application.

20. A computer readable storage medium having computer-executable instructions that, when executed by a computing device, cause the computing device to perform steps comprising:
receiving a plurality of files associated with a web application, wherein each of the plurality of files comprise a plurality of constituent content, and one or more of the plurality of files comprise a source language different from other files of the plurality of files;
parsing each of the plurality of files into respective constituent content;
associating an instance of parsed constituent content with a node of a dependency graph, wherein each node of the dependency graph represents a set of logical instructions of parsed constituent content selected from a group including: a function; and a method;
implementing an analysis of a plurality of relationships between parsed constituent content, wherein the plurality of relationships comprise a call dependency including a number of nodes of the dependency graph including a reference to each respective node, and a call frequency including a number of incoming references to a node of the dependency graph from other nodes of the dependency graph;
organizing the parsed constituent content into a plurality of partitions based on the analysis of the plurality of relationships, wherein the plurality of partitions are selectively organized to include constituent content most related to other constituent content and to minimize a number of references from constituent content of one of the plurality of partitions to another of the plurality of partitions;
generating a plurality of output files each corresponding to one of the plurality of partitions; and
transferring the plurality of output files to at least one other computing device configured to host the web application.
